(19) United States
(12) Patent Application Publication
(10) Pub. No.: US 2022/0012681 A1
(43) Pub. Date: Jan. 13, 2022

(54) MULTI-FACTOR AUTHENTICATION AT POINT OF SALE FOR MULTI-INGREDIENT PRODUCT TRACKING, TRACING, AND AUTHENTICATION

(71) Applicant: HealthLoq LLC, Mesa, AZ (US)

(72) Inventors: Todd Wendell Taylor, Mesa, AZ (US); Kenneth Alden Staker, Mesa, AZ (US); Derek James Lurth, Mesa, AZ (US)

(21) Appl. No.: 17/359,330

(22) Filed: Jun. 25, 2021

Related U.S. Application Data
(60) Provisional application No. 63/049,064, filed on Jul. 7, 2020.
(60) Provisional application No. 63/049,069, filed on Jul. 7, 2020.

(51) Int. Cl. G06Q 10/08; H04L 9/32

(52) U.S. Cl. CPC G06Q 10/0832; G06Q 10/0833; H04L 2209/56; H04L 2209/38; H04L 9/3236

(57) ABSTRACT

Some aspects of the present application relate to systems and methods for leveraging blockchain technology to enable multi-ingredient product tracking, tracing, and authentication. In some aspects, the systems and methods may be used for supply chain management of a multi-ingredient product, including products that are formed using one or more raw ingredients which have undergone change. In some aspects, the systems and methods provide actors present in the supply chain the ability to provide information and data pertaining to their role (e.g., the processes they follow, the material they buy, etc.) in the supply chain and store that information and data into one or more blocks of a blockchain.

### CROSS-REFERENCE TO RELATED APPLICATION

The present application claims the benefit of U.S. Provisional Patent Application No. 63/049,064, filed Jul. 7, 2020 and entitled “MULTI-FACTOR AUTHENTICATION AT POINT OF SALE FOR MULTI-INGREDIENT PRODUCT TRACKING, TRACING, AND AUTHENTICATION,” and U.S. Provisional Patent Application No. 63/049,069, filed Jul. 7, 2020 and entitled “SYSTEM AND METHOD FOR LINKING CONSUMER DATA WITH ONE OR MORE SUPPLIERS FOR PRODUCT TRACKING AND VALIDATION.” The present application is also related to U.S. patent application Ser. No. ______, filed concurrently herewith and entitled “SYSTEM AND METHOD FOR LINKING CONSUMER DATA WITH ONE OR MORE SUPPLIERS FOR PRODUCT TRACKING AND VALIDATION.” The disclosures of the above-identified applications are incorporated by reference herein in their entirety.

### TECHNICAL FIELD

The present application relates to systems and methods for enabling multi-ingredient product tracking, tracing, and authentication using a blockchain computing environment.

### BACKGROUND OF THE INVENTION

The supply chain for complex multi-ingredient products, such as organic supplements, usually begins at a farm, often in a foreign country and generally involves many independent actors—producers, brokers, transporters, processors, wholesalers, retailers, and consumers—who may not collaborate with each other. For example, these actors may be hesitant to share data that would allow for sending, validating, and reconciling data between different parties. As such, it is difficult to coordinate across multiple, disbursed and often disconnected supply chain actors, and this becomes an issue when companies who manufacture these complex products question the identity or quality of the ingredients they procure and consumers who buy these complex products question the identity or quality of the final product.

To overcome the uncertainties with product identity or quality, companies and consumers often rely on trade association watchdogs (e.g., Organic Trade Association) and certifiers (e.g., organic certifiers such as USDA Organic Certifiers) who work to ensure integrity of production throughout the entire chain of custody of products. However, consumers are often warned by these organic certifiers and watchdogs to beware of purchasing fraudulent products as certain bad actors use counterfeit or confusing logos—such as “Organic,” “Made with Organic,” “Certified Organic Ingredients,” “Natural,” or “No Adulterated Ingredients”—to evoke trust and imply that the product is organic or is made from organic ingredients when, in fact, that may not be the case. As such, it becomes difficult to identify legitimate products with truly organic ingredients.

Other solutions have been proposed to ensure integrity throughout the entire supply chain in order to evoke trust in consumers. In some cases, technology-enabled solutions, such as distributed ledger technology or blockchain-based solutions have been proposed. However, the available blockchain-based solutions only track or trace simple single ingredient products (e.g., milk, pork, beef, etc.) and do not possess capabilities to track, trace, and authenticate complex products (e.g., organic supplements, etc.) made with multiple different ingredients. Moreover, the existing solutions do not possess capabilities to track, trace, and authenticate products that are formed using one or more raw ingredients which have undergone change along the way. To illustrate, current solutions can track almonds from the place they are cultivated to the pack of almonds sold in a store, but the existing solutions are ill equipped to track almonds that are first transformed into oil and then mixed with other ingredients to form a final product. Stated another way, existing technologies enable a raw ingredient to be traced from the farm to the store, but are not able to track ingredients once they undergo transformations during processing.

### BRIEF SUMMARY OF THE INVENTION

The present application discloses systems and methods for leveraging blockchain technology to enable multi-ingredient product tracking, tracing, and authentication. The disclosed systems and methods are particularly suited for monitoring, verifying, and tracking multi-ingredient products through a supply chain, including products that are formed using one or more raw ingredients which have undergone changes during processing within the supply chain. In aspects, actors participating in the supply chain are provided with functionality to record information and data pertaining to their role (e.g., how ingredients are grown, how ingredients are processed, etc.) within the supply chain to a blockchain. Exemplary actors may include producers (e.g., entities that produce raw ingredients used to produce products), processors (e.g., entities that use one or more raw ingredients to produce sub-products or other components of a final product from the raw ingredients), transporters (e.g., entities that provide transportation services within the supply chain), manufacturers (e.g., entities that combine raw ingredients or sub-products to form final products), packagers (e.g., entities that provide packaging services for packing ingredients or final products), and distributors (e.g., entities that distribute raw ingredients, sub-products, or final products to other actors within the supply chain or consumers). It is noted that the exemplary actors described above have been provided for purposes of illustration, rather than by way of limitation.

As each actor performs their role, data pertaining to that role may be recorded to the blockchain. For example, a producer may grow a raw ingredient from seeds. The producer may record data to the blockchain pertaining to the origin of the seeds, the field(s) where the seeds were grown, the date the seeds were planted or harvested, watering schedules, etc., to a block of the blockchain. Once the raw ingredient is harvested, it may be picked up by a transporter and delivered to another actor within the supply chain, such as a processor. An identifier (e.g., a quick response (QR) code or other type of identifier) may be associated with the raw ingredients and may be scanned by the transporter when picking up the raw ingredient from the producer. The identifier may include information that identifies the block of the blockchain where the information provided by the producer is stored.

The transporter may record a new block to the blockchain associated with transportation of the raw ingredients to the processor, such as to record information associated with the location where the raw ingredients were picked up, the type of truck used to transport the raw ingredient (e.g., refrigerated truck, non-refrigerated truck, etc.), the destination where the raw ingredient was delivered, or other information. In an aspect, the block recorded by the transporter may include the transportation information described above and an identifier associated with the block created by the producer, thereby providing the ability to track the raw ingredient from the producer to the processor. Such processes may continue (e.g., the processor may create a new block that includes data generated by the processor and information identifying the transporter block, and so on) until the final product is delivered to a distributor or other final destination (e.g., a retail store). In an additional or alternative aspect, the block created by the transporter may incorporate the data included in the block created by the producer, thereby creating a single record (e.g., block on the blockchain) that includes all relevant data for the raw ingredient. Similarly, the processor may create a new block on the blockchain that includes the data created by the processor as well as the data from the transporter and the producer and this process may continue until the final product is provided to a distributor or other final destination (e.g., a retail store).

Using the techniques described above, relevant information for a final product may be traced back to the origins of one or more component ingredients regardless of whether any of the ingredients undergo transformations along the way. For example, cannabidiol (CBD) oil may be produced from hemp via various transformative processes, such as extracting oil from the hemp plant. Extracting the oil may involve various techniques (e.g., liquid extraction, oil infusion, or other techniques) which may be performed by a processor and different processors may utilize different techniques or combinations of techniques. Using the blockchain techniques described above, a bottle of CBD oil may be traced from a final destination (e.g., store shelf) back to the processor(s) that produced the CBD oil and then to a producer that produced the hemp from which the CBD oil was extracted. Additionally, the CBD oil may not include the fibrous materials of the hemp plant from which the CBD oil was extracted, but that fibrous material may have been used as an ingredient for other products, such as to make paper or clothing. Such other products may also be traced back to the producer using the techniques described herein, thereby enabling users to obtain a full snapshot of the ingredients and processes that were involved in making a final product despite transformative processes taking place with respect to at least some of the ingredients used to produce the final product. Such a snapshot associated with the product may provide suppliers, vendors, and other parties of a supply chain with valuable information related to the history of a product.

In addition to increasing visibility for suppliers, vendors, and other parties of the supply chain, techniques described herein may increase visibility of a consumer to aspects of the supply chain. For example, recording the genealogy associated with a product to a blockchain may enable a consumer to identify the sources of ingredients of the product, a transportation schedule of the ingredients, processes applied to the ingredients, or mixing of the processed ingredients, as illustrative examples. As a result, a consumer may be able to learn or verify information about a product, such as a country of origin of the product (or an ingredient of the product) or a classification of a product (such as an organic classification), as illustrative examples.

Further, in some aspects, recording the genealogy associated with a product to a blockchain may enable suppliers, vendors, and other parties of the supply chain to demonstrate compliance with sustainability, social justice, or environmental, social, and corporate governance (ESG) practices. For example, a consumer, government agency, regulatory body, or other party may access the genealogy to verify certain representations of a supplier, vendor, or other party, such as a representation that ingredients of a product are grown or manufactured using a renewable source of energy (e.g., by verifying that ingredients are grown at a farm that is powered by wind energy or hydropower).

In some cases, enabling verification of sustainability, social justice, or ESG practices may reduce certain costs associated with a product. As an illustrative example, certain government agencies or regulatory bodies may in some cases impose fines or penalties for failing to demonstrate compliance with certain sustainability, social justice, or ESG practices. In some cases, a vendor or other party may find it expensive, difficult, or infeasible to demonstrate compliance with such practices, such as if product ingredients are produced in a foreign jurisdiction, or if the supply chain includes a relatively large number of parties. To further illustrate, the data recorded to the blockchain may include testing data related to a product, such as certificates of analysis, third party testing results, and other quality control procedures. Such an approach may remove the need for, or reduce reliance on, one or more intermediaries (e.g., certifiers or watchdogs), as the parties involved in the supply chain may create a peer-to-peer trustless system. As a result, by recording the genealogy associated with a product to a blockchain, certain costs associated with demonstrating and verifying compliance with sustainability, social justice, or ESG practices may be reduced or avoided in some circumstances.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 shows a system configured to perform operations in accordance with embodiments of the present disclosure;

FIG. 2 shows a flow diagram illustrating functionality of information and data manager of FIG. 1, in accordance with aspects of the present disclosure; and

FIG. 3 shows a flow diagram illustrating functionality of the user data manager of FIG. 1, in accordance with aspects of the present disclosure.

### DETAILED DESCRIPTION OF THE INVENTION

It is noted that while the disclosure that follows may be described with reference to a blockchain, it will be appreciated that a blockchain may include or may be implemented using a variety of technologies. For example, it will be appreciated that “blockchain” may refer to (or may implemented using) a distributed ledger technology or a quantum leger technology, whether centralized or decentralized. In other examples, “blockchain” may refer to (or may implemented using) one or more other technologies. Further, while the disclosure that follows may be described with reference to tracking, tracing, and authentication of a multi-ingredient product, such as an organic supplement, it is to be appreciated that the disclosure herein may also be applicable to other items. For example, the disclosure herein may be applicable to a product such as a protein bar which is typically made using different ingredients, e.g., eggs, nuts, etc., or other types of manufactured products, such as electronics, mechanical devices, and the like.

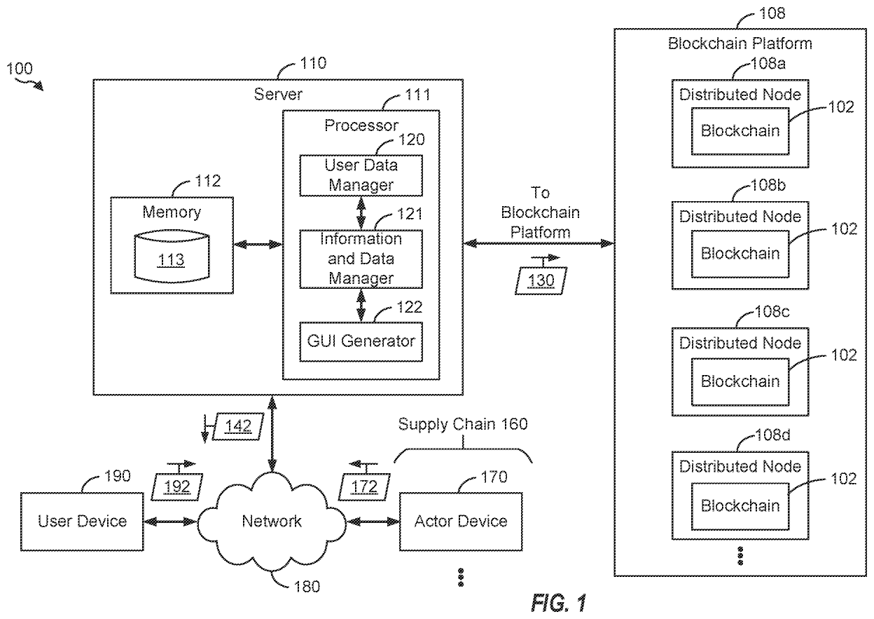

FIG. 1 is a block diagram of an exemplary system 100 configured with capabilities and functionality for tracking, tracing, and authentication of a multi-ingredient product. The system 100 may be used for supply chain management of the multi-ingredient product that is associated with a supply chain 160. The system 100 may be implemented as a software as a service (SAAS) solution system for providing an interface that may allow its users (e.g., actors in the supply chain 160 of the multi-ingredient product) the ability to input and store data in one or more blocks of a blockchain 102.

The system 100 may be configured to allow each actor in the supply chain 160 to create records (or blocks) in a blockchain computing environment (e.g., the blockchain 102) that contain information and data pertaining to their role in producing a multi-ingredient product. It is noted that the blockchain 102 may be a public blockchain (e.g., Ethereum) or a private blockchain. As will become apparent from the description that follows, the system 100 provides capabilities that may give each actor real-time visibility into the history of ingredients, sub-products, etc. involved in the manufacture of a final product via immutable records that provide true details related to the ingredients and processing of ingredients during manufacture of the final product. The data recorded to the blockchain 102 may also include testing data related to testing of the final product, such as certificates of analysis, third party testing results, and other quality control procedures. Such an approach may remove the need for, or reduce reliance on, one or more intermediaries (e.g., certifiers and watchdogs), as the actors involved in the supply chain 160 may create a peer-to-peer trustless system.

System 100 includes blockchain platform 108, server 110, one or more actor devices 170, network 180, and user device 190. As shown in FIG. 1, server 110 includes processor 111, memory 112, database 113, user data manager 120, information and data manager 121, and GUI generator 122. Depending on the implementation, the processor 111 may include, may be coupled to, or may execute instructions corresponding to one or more of the user data manager 120, the information and data manager 121, or the GUI generator 122. It is noted that the various components of server 110 are illustrated as single and separate components in FIG. 1. However, this illustration is made for illustrative purposes only and not intended to be limiting in any way. It will be appreciated that each of the various components of server 110 may be a single component (e.g., a single application, server module, etc.), may be functional components of a same component, or the functionality may be distributed over multiple devices or components. In such aspects, the functionality of each respective component may be aggregated from the functionality of multiple modules residing in a single, or in multiple devices.

Processor 111 may comprise a central processing unit (CPU) having one or more processor cores, a microprocessor, a controller, a microcontroller, a plurality of microprocessors, an application-specific integrated circuit (ASIC), an application-specific standard product (ASSP), or any combination thereof, and may be configured to execute instructions to perform operations in accordance with the disclosure herein. In some aspects, implementations of processor 111 may comprise code segments (e.g., software, firmware, hardware logic, or a combination thereof) executable in hardware, such as a processor, to perform the tasks and functions described herein. Processor 111 may be communicatively coupled to memory 112.

Memory 112 may comprise read only memory (ROM) devices, random access memory (RAM) devices, one or more hard disk drives (HDDs), flash memory devices, solid state drives (SSDs), other devices configured to store data in a persistent or non-persistent state, network memory, cloud memory, local memory, or a combination of different memory devices. Memory 112 may store instructions that, when executed by processor 111, cause processor 111 to perform operations in accordance with the present disclosure.

Memory 112 may also be configured to facilitate storage operations. For example, memory 112 may comprise database 113 for storing supply chain management information (e.g., actors involved, contact information, details about the product, information and data requirements for each actor, etc.), timer information (e.g., for determining or storing the expiration time of the quality verification certificates), generated smart contracts, analytics data, actor preferences, etc., which system 100 may use to provide the features discussed herein. In some implementations, the supply chain management information may be provided by actors of the supply chain 160. Database 113 may be integrated into memory 112, or may be provided as a separate module. In some aspects, database 113 may be a single database, or may be a distributed database implemented over a plurality of database modules. In some embodiments, database 113 may be provided as a module external to server 110.

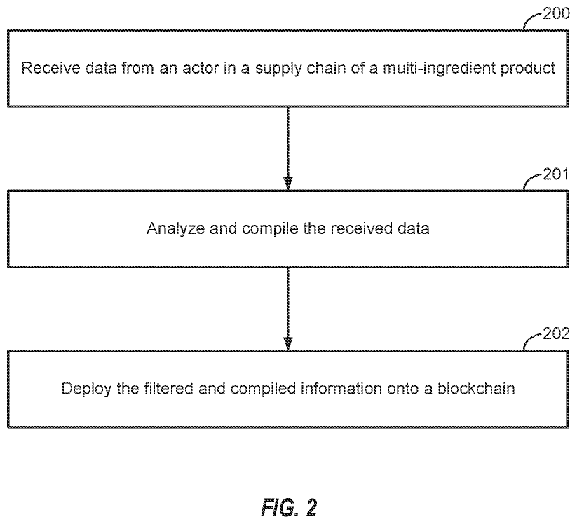

Information and data manager 121 may be configured to provide functionality to receive, analyze, filter, or compile information received from an actor, and to record data provided by actors to the blockchain 102. Additional details regarding the functionality of information and data manager 121 are described with respect to FIG. 2.

These components, and their individual components, may cooperatively operate to provide functionality in accordance with the discussion herein. In some aspects, the functionality of system 100 may be provided, at least in part, as a web-based program, as a stand-alone application (e.g., mobile, or desktop-based), as a cloud-based application, as an application programming interface (API), or other implementation that enables actors to provide information to and receive information from the blockchain 102. In aspects, the blockchain platform 108 may be implemented via a distributed ledger maintained by a plurality of distributed nodes 108a, 108b, 108c, and 108d. The distributed ledger may include or correspond to the blockchain 102.

Network 180 may include a wired network, a wireless communication network, a cellular network, a cable transmission system, a Local Area Network (LAN), a Wireless LAN (WLAN), a Metropolitan Area Network (MAN), a Wide Area Network (WAN), the Internet, the Public Switched Telephone Network (PSTN), or combinations of these and public or private networks, and may facilitate communications between any of server 110, actor devices 170, and blockchain platform 108.

The actor devices 170 may include one or more computing devices, such as laptop computing devices, desktop computing devices, tablet computing devices, smartphones, personal digital assistants (PDAs), Internet of Things (IoT) devices (e.g., sensors, etc.), or other types of devices that may enable actors to provide information and data pertaining to their role in the supply chain. The information and data may be communicated, via network 180, to server 110. Server 110 may include functionality to deploy data received from the actors to blocks of the blockchain 102. It is noted that although a single actor device 170 and a single user device 190 are shown in FIG. 1, it is to be understood that the system 100 may include more than one actor device and more than one user device, or both.

One of the first actors in the supply chain 160 may be an ingredient producer, such as a farmer that grows crops that may be processed to produce products (e.g., nutritional supplements, vitamins, etc.). Ingredient producers may provide data to the blockchain platform 108 related to various aspects of growing the one or more ingredients. To illustrate, ingredient producers may provide information regarding the type of seeds used to produce the ingredient, the land on which the seeds were sown, the amount of water and other substances (e.g., herbicides, fungicides, pesticides, fertilizer, etc.) applied as the seeds were grown, a date of harvest, weather conditions (e.g., humidity, temperature, rainfall, and the like) over the growing period. The server 110 may record the information provided by the producer to a block on the blockchain 102.

Subsequently, a second actor in the supply chain 160, such as a transporter, may be tasked with picking up the harvested ingredients from the producer. To facilitate pickup of the ingredients, the producer may apply or otherwise associate an identifier with the raw ingredients. The identifier may include a label applied to the ingredients or a container housing the ingredients for transport, as illustrative examples. In aspects, the identifier may include a quick response (QR) code, a bar code, an alphanumeric string, or other types of identifiers that may be used to identify the ingredients. Information identifying the block where the ingredient data is recorded to the blockchain 102 may be embedded within the identifier. When the transporter arrives to pick up the ingredients, the identifier may be scanned, thereby informing the transporter (and a device of the transporter) of the block where the ingredient data is recorded on the blockchain 102. The transporter may then deliver the ingredients to another actor in the supply chain 160, such as a producer that processes the ingredients to prepare them for incorporation with other ingredients as part of a process to produce a final product. Upon delivering the ingredients to the processor, the transporter may provide information to the server 110 related to the transport of the ingredients from the producer to the processor, such as the pickup location and time, the distance travelled, the type of truck (or other type of vehicle) used to transport the ingredients, time of delivery, delivery location, etc., and the transport data may be recorded to the blockchain 102.

In an aspect, the transportation data provided by the transporter may be recorded to a block of the blockchain 102 that is different from the block where the producer data is recorded. In such an implementation, the block storing the transportation data may include information that identifies the block where the producer data is recorded, thereby enabling the transportation data to be associated with the producer data. In an additional or alternative aspect, the block created by the transporter may include the transportation data and the data of the producer. For example, transporter may include the identifier of the block where the producer data is stored, which may have been obtained when scanning the identifier upon picking up the ingredients from the producer, with the transport data provided to the server 110, and the server 110 may aggregate the transport data with the data of the producer block into a new block (e.g., a block that includes both the transport data and the producer data).

Subsequently, the processor receiving delivery of the ingredients from the transporter may subject the ingredients to one or more processes. To illustrate, the ingredient may be hemp and the processor may subject the hemp to various processes to extract CBD oil from the hemp. Once the CBD oil is extracted from the hemp, the oil may be transported to a second processor where the CBD oil is combined with other ingredients (e.g., mineral oil, etc.) to produce a final product (e.g., CBD balm, lotion, etc.), and the fibrous material of the hemp plants may be transported to a third processor where the fibrous material is used to manufacture other products (e.g., paper, clothing, and the like). The processor extracting the CBD oil may record data to the blockchain 102 associated with the extraction of the CBD oil from the hemp, such as the particular extraction technique that was used, the quantity of oil extracted, etc. As described above, the processing data generated by the producer may be recorded as a new block on the blockchain 102 that identifies the transporter block (e.g., the block containing data relevant to the stage of the supply chain immediately preceding the processor) or may be recorded in a new block that aggregates the processing data with the transport data and the producer data (e.g., a block that includes the producer data, the transport data, and the processor data).

Similar operations may be performed by the actors in the supply chain 160 that utilize the sub-products produced as a result of the processing by the processor. For example, additional transport blocks may be recorded to the blockchain 102 associated with transport of the CBD oil to the second processor and transport of the fibrous material to the third processor. These additional transport blocks may represent a split in the supply chain, where one block corresponds to transport of a first sub-product (e.g., the CBD oil) derived from the ingredients via processing by the processor and the other block corresponds to transport of a second sub-product (e.g., the fibrous material). These additional transport blocks may be recorded as separate blocks (e.g., two transport data blocks identifying the processor block, which in turn identify the transport block having information that identifies the producer block) or may be aggregated with one or more previously created blocks of the blockchain 102 (e.g., one transport block corresponding to transport of the CBD oil to the second processor and including the producer data, the transport data, and the processor data and one transport block corresponding to transport of the fibrous material to the third processor and including the producer data, the transport data).

To further illustrate, in some examples, the actor device 170 may be associated with any of actors described above, such as the ingredient producer (e.g., a farmer), the transporter, the processor, or another actor. Further, each actor may transmit respective data 172 to the server 110, where the respective data 172 indicates the producer data, the transportation data, or the processing data, as illustrative examples. The server 110 may store at least a portion 130 of the data 172 to the blockchain 102. Accordingly, data from the supply chain 160 may be stored or indicated in the blockchain 102.

As shown above, despite transformation of the raw ingredient into a different sub-product (e.g., CBD oil), embodiments may enable tracking of the sub-product back to the producer and intermediate processing and transportation steps, thereby enabling full transparency to be achieved within the supply chain 160 despite intermediate transformations of ingredients due to processes performed within the supply chain 160. It is noted that the final product may include an identifier that enables the history of that product (e.g., from producer to distributor or retailer) to be obtained from the blockchain 102. For example, where individual records are used for each actor, the identifier provided with the final product may identify a block associated with the distributor (or retailer) receiving delivery of the final product from a transporter. That block may also include information that identifies a transporter block associated with transportation of the final product from a packaging actor to the distributor, the transport block may identify a block associated with intermediate supply chain operations performed prior the packaging actor, and so on until blocks of the blockchain 102 identifying the source each ingredient incorporated into the final product are obtained. Where a single block is used (e.g., by aggregating previous block data each time a new block is created), the final product may identify a block of the blockchain 102 where the aggregated data corresponding to the final product may be obtained.

In aspects, server 110 may include functionality to condition the information and data (such as the data 172) received from the various participating actors prior to deploying the data to the blockchain 102. As an example, deploying the information and data may include creating multiple asset records in the blockchain 102. Each asset record of the multiple asset records may correspond to an actor of the supply chain 160 and may be configured to store data associated with the corresponding actor. To further illustrate, a first asset record may be associated with a farmer that is included in the supply chain 160, and a second asset record may be associated with a transporter that is included in the supply chain 160. The first asset record may indicate farming techniques used by the farmer, and the second asset record may indicate a transportation schedule associated with transportation of the ingredients by the transporter, as illustrative examples.

In some examples, the server 110 may be configured to filter data recorded to the blockchain 102 (e.g., by applying a set of rules to data to generate the filtered data). In aspects, the filtering of data may be based on the amount and type of data received from an actor. For instance, some data (e.g., data indicating an amount of water used to grow the crops) provided by the actor may not be considered important to the efficacy and effectiveness of the final product and may not be recorded to the blockchain 102 while other data that is considered important to the efficacy and effectiveness of the final product may be recorded to the blockchain 102. In such an embodiment, the server 110 may include functionality to limit the data recorded to the blocks such that only data that is meaningful is recorded to the blockchain 102. In an aspect, portions of the data that are not recorded to the blockchain 102 may be stored “off-chain” rather than being stored and replicated across nodes of the blockchain 102 (i.e., “on-chain”). When data is stored “off-chain” it may be stored separate from the blockchain 102 (e.g., on a cloud-based storage or other data storage infrastructure accessible to the server 110 or another device of the system 100).

In aspects, the information and data provided by actors may be recorded to a separate database (e.g., cloud-base database, local database, etc.) and a hash of the information and data may be recorded to the blockchain 102. This may allow the information and data to be retained privately but still be authenticated by third parties (e.g., by giving the third parties access to the data, calculating a new hash value, and comparing to the calculated hash value to the hash value recorded on the blockchain 102 to verify the “off-chain” data has not been modified or manipulated). This technique may be used to incrase the security of the data for each actor and provide more control over data access. For example, an actor that combines several ingredients in a specific way (e.g., based on particular ratios of ingredients, mixing times, temperatures, etc.) may not record such information on a public blockchain as it may be possible for a competitor to obtain insights into how the actor processes ingredients. Storing the sensitive data “off-chain” and recording a hash of the data on the blockchain 102 may allow the actor to provide authorized supplychain participants with access to the data and mechanisms to verify authenticity of the data while preventing potential misuse of the data by unauthorized third parties. Alternatively or additionally, data recorded to the blockchain 102 may be encrypted and appropriate decryption keys may be managed and shared by the owners of the data (e.g., the actors that generated the data). It is noted that the particular mechanisms utilized to condition data recorded to the blockchain 102 have been provided for purposes of illustration, rather than by way of limitation, and that other techniques may be used to manage and control how data is recorded to and accessed from the blockchain 102.

Actor device 170 may include one or more devices configured to present an interface to facilitate actor input and output operations in accordance with aspects of the present disclosure. The interface may include a graphical user interface (GUI). In aspects, the GUI may be configured and generated by GUI generator 122 of server 110, discussed in more detail below. In embodiments, an actor may use the GUI to provide information and data about their role in the supply chain 160. To illustrate, the information and data input by the producers may include farming information, including the type of seeds used to produce the ingredient, the land on which the seeds were sown, the amount of water and pesticides that were used, etc. To further illustrate, actors that process ingredients at final or intermediate stages of the supply chain 160 may also provide information and data related to processes performed to produce one or more semi-processed or processed products from the multiple ingredients. Additionally, actors responsible for assembly and packaging may also provide quality verification-related information, labeling-related information, etc. In addition to providing inputs via the GUI, actors may also utilize other techniques to provide data to the server 110 or compile data for recording to the blockchain 102. As an example, various sensors may be deployed by an actor to capture information associated with the actor's activities and processes, such as to record weather data associated with a crop being grown by a producer, temperature data associated with a process performed by a processor, or other types of data.

It is noted that while exemplary operations and actors have been described above as producing a final product from multiple ingredients, additional types of data may be recorded to the blockchain 102 by actors in accordance with aspects of the present disclosure, such as testing data associated with quality, concentration, or other types of testing and metrics may be provided to the server 110 for recording on the blockchain 102 in connection with a final product. For example, an actor may perform quality testing on one or more raw ingredients (e.g., obtained from a producer or a processor) to verify that the ingredient(s) is organic, of a stated quality, etc. The testing data may be recorded to the blockchain 102 using the techniques described above and provides additional data points by which a final product may be evaluated and tracked.

User device 190 may be configured to present an interface that delivers relevant information from the blockchain 102 to users, such as consumers who buy the final product or companies who own the product. In embodiments, a user may use the GUI to review information and data about the final product. To illustrate, the final product may include an identifier that identifies a block on the blockchain 102, which may be a block corresponding to a last processing step in the supply chain 160 prior to a user (e.g., a consumer or retailer) obtaining the final product and that identifies a previous block, and so on, or may be a block that includes aggregated information related to the product. The user may scan or otherwise input the identifier into the GUI, which may initiate transmission of a request 192 for information and data relevant to the product to the server 110.

In response to the request 192, the server 110 may identify a genealogy data structure corresponding to the final product. The genealogy data structure may include one or more blocks of the blockchain 102 storing data corresponding to the final product, such as the data 172 or the portion 130 of the data 172. In some aspects, identifying the genealogy data structure includes determining a most recently recorded block of the blockchain 102 corresponding to the final product, and the block of the blockchain 102 storing at least the portion 130 of the data 172 includes information that identifies the most recently recorded block of the blockchain 102. In response to identifying and retrieving the genealogy data structure, the server 110 may transmit data 142 recorded to the one or more blocks of the blockchain 102 corresponding to the genealogy data structure.

The user device 190 may receive the data 142 relevant to the product from the blockchain 102 for presentation to the user. For example, the data 142 may include information related to the source of each ingredient used to make the product, quality verification and testing information (e.g., microbial testing, metal testing, pesticide testing, potency testing, etc.) of the final product, quality verification and testing information for each of the ingredients, key dates pertaining to the quality verification and testing information, dates on which the ingredients were shipped from the producer, details related to the processes that were applied on each of the ingredients, or other types of information.

The ability to trace a final product back to the source of its constituent ingredients despite any ingredient-transformations that may have taken place may provide significant advantages over existing technologies. Being able to trace each ingredient from its source to the final product, along with the ability to obtain information about any intermediate processes to which any of the ingredients were subjected, may enable final-product owners to determine whether sources of ingredients are inferior as compared to other sources for those same ingredients. To illustrate, if test results for a final product made with an ingredient supplied by two different suppliers reveal that a quality of the final product is better when produced using the ingredient provided by one of the suppliers as compared to the other, the product manufacturer may forego obtaining the ingredient from the inferior supplier and either find another supplier or use the higher quality supplier. Moreover, because the processes used to grow the ingredients may be recorded to the blockchain 102, testing results may be analyzed and correlated to different aspects of the growing processes, which may reveal that certain growing conditions (e.g., climate, location, soil pH, watering schedule, temperature, humidity, etc.) produce superior ingredients, which may allow producers to refine their growing processes and optimize production of raw ingredients. Additionally, effectiveness testing may be performed where users try the final product (e.g., a nutritional supplement) and provide feedback regarding the effects that the final product had on the users. Such data may be used to identify correlations between the effectiveness of active ingredients and the processes those ingredients are subjected to during manufacturing of the final product, which may enable more effective final products to be produced, manufacturing processes to be refined, and the like.

Referring to FIG. 2, a flow diagram illustrating functionality of information and data manager 121 in accordance with aspects of the present disclosure is shown. At block 200, information and data from an actor is received. In aspects, receiving information and data may include receiving input information from the actor via a GUI presented to the actor, as described above. The information and data may be provided by one or more of a user operating the device or an external device (e.g., sensors, etc.). For example, in case of an ingredient producer, the information may be sent by the producer using a device, such as a smart device (e.g., smart phone using an application). In aspects, the information and data may be provided by an API at a computer system that sends information and data to the information and data manager 121. For example, in case of a processor actor, the information may be sent automatically via an API upon receiving information and data (e.g., data indicating a quality verification test certificate, a temperature at which the ingredients were processed, a type of machinery and process used, etc.) that is to be shared. In some aspects, the information and data may be received automatically (i.e., without any human intervention). For example, upon setting the temperature at which the ingredients were processed, the API may automatically receive the temperature data from the machine. In aspects, the information and data manager 121 is also configured to receive information and data from internet of thing (IoT) devices, RFID (or NFC embedded ID chips), GPS-enabled smart logbooks, smart packaging and digitized labels, tamper-evident seals, etc. that are used by an actor. For example, IoT devices (e.g., network enabled weather, humidity, rain, temp sensors) may be deployed in fields where raw ingredients are grown to monitor weather data and that data may be transmitted for recording on the blockchain 102.

Moreover, as noted above, the information and data received from actors present in the supply chain 160 may relate to their role within the supply chain 160. To illustrate, each producer of raw ingredients may input or store information and data related to the ingredients produced by them at a block of the blockchain 102, such as the type of seeds used to produce the ingredient, the land on which the seeds were sown, the amount of water and pesticides that were used, and the like. One or more processors may receive multiple different ingredients from different producers and record information and data to the blockchain 102 related to: the processes that are performed by the one or more processors; the type of machinery used in the one or more processes, temperature used in each one of those one or more processes; raw material other than the ones received from the producers (e.g., local water) used in the one or more processes; the resulting new ingredient of the process; the materials used to produce the new ingredient; the amount of new ingredient that was produced per unit of the input ingredient, etc.

Sharing data among actors within the supply chain 160 using techniques described herein may enable interested parties (e.g., consumers, etc.) to track, trace, and authenticate products that are formed using one or more raw ingredients which have undergone change along the way. To illustrate, the blockchain-based techniques described herein may enable a consumer to trace a product made using almond oil back to the farm where the almonds were cultivated, the processor where the almond oil was extracted (e.g., by cold pressing, etc.), along with tracing any other ingredients included in the final product back to their origins and intermediate processors. Additionally, users may be able to track, trace, and authenticate quality and certification data for the products, such as to view information that proves the final product is organic.

At block 201, the received data and information is analyzed, filtered, compiled, or a combination thereof. In aspects, information and data manager 121 is configured to filter out data that is not to be deployed to the blockchain 102. To illustrate, information and data manager 121 may be configured to parse the information and data into a first dataset and a second dataset (e.g., one dataset which is to be recorded to the blockchain 102 and one that is not). The dataset that is not deployed on the blockchain 102 may be stored elsewhere, separate from the blockchain 102 (e.g., at the database 113, a cloud-based storage, and the like). In aspects, the filtering of received information and data may be done based on a configurable set of rules, which may be set by a supply chain manager. In aspects, the configurable set of rules may be set by actors themselves. In aspects, once the received data and information is filtered, the information and data manager 121 is configured to compile the data. In aspects, compiling the data may include obtaining data associated with a previous supply chain step, such as an identifier associated with a block of the blockchain 102 corresponding to an immediately preceding supply chain step, for inclusion in a newly created block (e.g., to establish a link between two steps of the supply chain 160 that enables one step to be traced back to the previous step). In additional or alternative aspects, compiling the data may include obtaining data associated with previous supply chain steps for inclusion in the newly created block (e.g., where each actors block data is incorporated into the block data of a subsequent actor).

At block 202, the filtered and compiled information is deployed onto a blockchain. As such, the information and data manager 121 is further configured to deploy the filtered and compiled information and data into the blockchain 102. The deploying may include creating a new block on the blockchain 102, as described above. Once information is deployed onto the blockchain 102, an actor in the supply chain 160 may access data on the blockchain 102 related the other actors. For example, an actor user may want to access data related to the concentration of a raw ingredient or a new ingredient formed using a raw ingredient produced by another actor. In such scenarios, an actor in the supply chain 160 may access this data via the actor device 170, and the data may be provided to the actor device 170 by the information and data manager 121. In aspects, the information may be accessed via a GUI generated by GUI generator 122, as described above.

In aspects, access to the data recorded to the blockchain 102 may be restricted using a set of permissions. For example, one producer of an ingredient may configure permissions that enable certain actors in the supply chain 160 to access the producer's data from the blockchain 102, but other actors (e.g., other producers that produce the same ingredient) may be prevented from accessing the producer's data (e.g., by configuring permissions that deny the other actors access to the producer's data blocks). As another example, restricting access to blockchain data may be accomplished via encryption of data recorded to the blockchain 102 and a data owner may grant permission to access data by providing an appropriate decryption key to authorized actors. Additionally or alternatively, once information is deployed onto the blockchain 102, an actor in the supply chain 160 may only access certain information on the blockchain 102 related to the other actors used. For instance, an intermediate processor may allow a downstream processor to view where the intermediate processor sourced ingredients, but not the particular ratios of ingredients or how they were processed to form one or more new ingredients, but the same intermediate processor may allow a third party organization certifying the product to have that information. This selective access to data pertaining to the information and data provided by an actor may be controlled by the actor providing the data. To illustrate, the actor after deploying the data into the blockchain 102 may configure the information and data manager 121 for permission-based access to its blockchain data. The permission-based blockchain access provides an additional blockchain security system, as it maintains an access control configuration to allow certain actions (e.g., accessing blockchain data) to be performed only by certain identifiable participants (e.g., third party quality control laboratories).

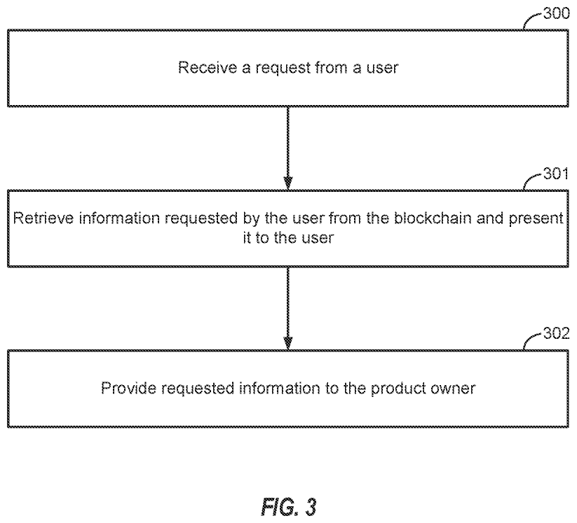

Referring back to FIG. 1, user data manager 120 may be configured to receive a request from an owner of the final product, and to provide to the owner of the final product information derived from the information and data deployed on the blockchain by the actors involved in the supply chain 160 of the multi-ingredient product. Exemplary aspects of functionality provided by user data manager 120 are illustrated and described with reference to FIG. 3, which shows a flow diagram illustrating functionality of user data manager in accordance with aspects of the present disclosure.

At block 300, a request from a user of the final product is received. In aspects, receiving the request may include receiving the request from the user via a GUI generated by GUI generator 122, as described above. The user may be a product owner and the GUI may enable the product owner to request information about the product. In requesting information about the product, in aspects, the GUI for the user may provide the user interactive elements (e.g., the GUI may present one or more interactive elements to the product owner). In aspects, the interactive elements may include check boxes, radio buttons, URLs, buttons, or other interface elements that the user may activate to make selections or provide inputs to the GUI. Additionally or alternatively, the user may be a user other than the product owner, such as an intermediary actor in the supply chain 160 that may want to access upstream data on the blockchain 102 related to ingredients the intermediary actor uses.

At block 301, upon receiving the request, the user data manager 120 may retrieve information requested by the user from the blockchain and present it to the user. In an aspect, the presentation of the retrieved data may be configured based on a template. In aspects, after receiving the retrieve information request, the user data manager 120 obtains a stored template (e.g., premade design framework of a web page that acts as a template) for that product, and use information retrieved from the blockchain 102 to add to the template. As an example, the template may include the following titles: description of the product, storage information of the product, usage directions of the product, warnings related to the product, batch details of the product, production date of the product, concentration of various derived ingredients (e.g., total CBD concentration, total terpene concentration, total THC concentration, etc.) of the product, location information of where each one of the ingredients were sourced that make up the product, quality verification and testing information (e.g., microbial testing, metal testing, pesticide testing, potency testing, etc.) of the final product, quality verification and testing information for each of the ingredients, key dates pertaining to the quality verification and testing information, dates on which the ingredients were shipped from the producer, details related to the processes that were applied on each of the ingredients, etc. At block 302, the user data manager 120 completes the template and provides the requested information to the product owner.

In some aspects of the disclosure, a method for creating genealogy data structures for tracing a final product back to its source ingredients includes receiving first data (e.g., the data 172) associated with a first actor (e.g., the actor device 170 or an actor associated with the actor device 170) in a supply chain (e.g., the supply chain 160). The first data includes information indicating a first ingredient of the ingredients and one or more processes executed by the first actor with respect to the first ingredient. The method further includes recording at least a portion of the first data (e.g., at least the portion 130 of the data 172) to a block of a blockchain (e.g., to a block of the blockchain 102). The method further includes, in response to a request to access genealogy data corresponding to the final product (e.g., in response to the request 192), identifying a genealogy data structure corresponding to the final product. The genealogy data structure includes one or more blocks of the blockchain storing data corresponding to the final product, and the data corresponding to the final product includes at least the portion of the first data. The method further includes transmitting second data recorded to the one or more blocks of the blockchain corresponding to the genealogy data structure. The second data may correspond to the data 142.

In some examples, the method further includes recording at least the portion of the first data, which may include creating a new block on the blockchain.

The method may further include compiling information recorded to one or more previously created blocks of the blockchain associated with the final product, aggregating the compiled information with at least the portion of the first data to produce aggregated data, and recording the aggregated data to the block of the blockchain.

The method may further include determining a most recently recorded block of the blockchain corresponding to the final product, where the block of the blockchain storing at least the portion of the first data comprises information that identifies the most recently recorded block of the blockchain.

In some examples, the method further includes deploying at least some of the first data. Deploying the at least some of the first data includes creating multiple asset records, and each asset record of the multiple asset records may correspond to an actor of the supply chain and may be configured to store data associated with the corresponding actor.

In some examples, the method further includes applying a set of rules to the first data to generate filtered data. The filtered data may correspond to at least the portion of the first data recorded to the block of the blockchain.

In some examples, one or more previously created blocks of the blockchain associated with the final product include testing data associated with testing of the final product, testing of one or more ingredients incorporated into the final product, or both.

In some examples, at least one ingredient incorporated into the final product is produced via transformation of a raw ingredient into a different state.

In some aspects, a system (e.g., the server 110) includes a memory (e.g., the memory 112) and one or more processors (e.g., the processor 111) coupled to the memory and configured to perform operations of the method, one or more other operations described herein, or a combination thereof. In some aspects, a non-transitory computer-readable medium (e.g., the memory 112) stores instructions executable by a processor (e.g., the processor 111) to initiate, perform, or control operations of the method, one or more other operations described herein, or a combination thereof.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, the scope of the present application is not intended to be limited to the particular embodiments of the process, machine, manufacture, composition of matter, means, methods and steps described in the specification.

What is claimed is:

1. A method for creating genealogy data structures for tracing a final product back to its source ingredients, the method comprising,
receiving first data associated with a first actor in a supply chain, wherein the first data includes information indicating a first ingredient of the ingredients and one or more processes executed by the first actor with respect to the first ingredient;
recording at least a portion of the first data to a block of a blockchain; and
in response to a request to access genealogy data corresponding to the final product:
identifying a genealogy data structure corresponding to the final product, the genealogy data structure comprising one or more blocks of the blockchain storing data corresponding to the final product, the data corresponding to the final product including at least the portion of the first data; and
transmitting second data recorded to the one or more blocks of the blockchain corresponding to the genealogy data structure.

2. The method of claim 1, wherein recording at least the portion of the first data includes creating a new block on the blockchain.

3. The method of claim 2, further comprising:
compiling information recorded to one or more previously created blocks of the blockchain associated with the final product;
aggregating the compiled information with at least the portion of the first data to produce aggregated data; and
recording the aggregated data to the block of the blockchain.

4. The method of claim 2, further comprising determining a most recently recorded block of the blockchain corresponding to the final product, wherein the block of the blockchain storing at least the portion of the first data comprises information that identifies the most recently recorded block of the blockchain.

5. The method of claim 1, further comprising deploying at least some of the first data, wherein deploying the at least some of the first data includes creating multiple asset records, and wherein each asset record of the multiple asset records corresponds to an actor of the supply chain and is configured to store data associated with the corresponding actor.

6. The method of claim 1, further comprising applying a set of rules to the first data to generate filtered data, the filtered data corresponding to at least the portion of the first data recorded to the block of the blockchain.

7. The method of claim 1, wherein the one or more previously created blocks of the blockchain associated with the final product comprise testing data associated with testing of the final product, testing of one or more ingredients incorporated into the final product, or both.

8. The method of claim 1, wherein at least one ingredient incorporated into the final product is produced via transformation of a raw ingredient into a different state.

9. A system comprising:
a memory; and
one or more processors coupled to the memory and configured to:
receive first data associated with a first actor in a supply chain, wherein the first data includes information indicating a first ingredient of the ingredients and one or more processes executed by the first actor with respect to the first ingredient;
record at least a portion of the first data to a block of a blockchain; and
in response to a request to access genealogy data corresponding to a final product:
identify a genealogy data structure corresponding to the final product, the genealogy data structure comprising one or more blocks of the blockchain storing data corresponding to the final product, the data corresponding to the final product including at least the portion of the first data; and
transmit second data recorded to the one or more blocks of the blockchain corresponding to the genealogy data structure.

10. The system of claim 9, wherein the one or more processors are further configured to create a new block on the blockchain and to record at least the portion of the first data to the new block on the blockchain.

11. The system of claim 10, wherein the one or more processors are further configured to:
compile information recorded to one or more previously created blocks of the blockchain associated with the final product;
aggregate the compiled information with at least the portion of the first data to produce aggregated data; and
record the aggregated data to the block of the blockchain.

12. The system of claim 10, wherein the one or more processors are further configured to determine a most recently recorded block of the blockchain corresponding to the final product, wherein the block of the blockchain storing at least the portion of the first data comprises information that identifies the most recently recorded block of the blockchain.

13. The system of claim 9, wherein the one or more processors are further configured to deploy at least some of the first data by creating multiple asset records, and wherein each asset record of the multiple asset records corresponds to an actor of the supply chain and is configured to store data associated with the corresponding actor.

14. The system of claim 9, wherein the one or more processors are further configured to apply a set of rules to the first data to generate filtered data, the filtered data corresponding to at least the portion of the first data recorded to the block of the blockchain.

15. The system of claim 9, wherein the one or more previously created blocks of the blockchain associated with the final product comprise testing data associated with testing of the final product, testing of one or more ingredients incorporated into the final product, or both.

16. The system of claim 9, wherein at least one ingredient incorporated into the final product is produced via transformation of a raw ingredient into a different state.

17. A non-transitory computer-readable storage medium storing instructions that, when executed by one or more processors, cause the one or more processors to perform operations, the operations comprising:
receiving first data associated with a first actor in a supply chain, wherein the first data includes information indicating a first ingredient of the ingredients and one or more processes executed by the first actor with respect to the first ingredient;
recording at least a portion of the first data to a block of a blockchain; and
in response to a request to access genealogy data corresponding to a final product:
identifying a genealogy data structure corresponding to the final product, the genealogy data structure comprising one or more blocks of the blockchain storing data corresponding to the final product, the data corresponding to the final product including at least the portion of the first data; and
transmitting second data recorded to the one or more blocks of the blockchain corresponding to the genealogy data structure.

18. The non-transitory computer-readable storage medium of claim 17, wherein recording at least the portion of the first data includes creating a new block on the blockchain.

19. The non-transitory computer-readable storage medium of claim 18, wherein the operations further comprise:
compiling information recorded to one or more previously created blocks of the blockchain associated with the final product;
aggregating the compiled information with at least the portion of the first data to produce aggregated data; and
recording the aggregated data to the block of the blockchain.

20. The non-transitory computer-readable storage medium of claim 18, wherein the operations further comprise determining a most recently recorded block of the blockchain corresponding to the final product, wherein the block of the blockchain storing at least the portion of the first data comprises information that identifies the most recently recorded block of the blockchain.
